(19) United States
(12) Patent Application Publication
(10) Pub. No.: US 2021/0296924 A1
(43) Pub. Date: Sep. 23, 2021

(54) CHARGING DEVICE

(71) Applicant: HONDA MOTOR CO., LTD., Tokyo (JP)

(72) Inventors: Noriyuki ABE, Saitama (JP); Yoshio KOJIMA, Saitama (JP)

(73) Assignee: HONDA MOTOR CO., LTD., Tokyo (JP)

(21) Appl. No.: 17/185,249

(22) Filed: Feb. 25, 2021

(30) Foreign Application Priority Data
Mar. 19, 2020 (JP) 2020-050279

(51) Int. Cl. H02J 7/35; H02J 7/00

(52) U.S. Cl. CPC H02J 7/35; H02P 27/06; H02J 7/0013

(57) ABSTRACT

A charging device that charges a battery mounted in a vehicle, the battery having cells connected in series, the cells being configured as cell units each including at least one of the cells, the charging device includes a solar battery and a charging circuit configured to selectively supply electric power generated by the solar battery to each of the cell units. The charging circuit includes electric power adjustment units provided between the solar battery and the cell units, and each of the electric power adjustment units is associated with one or more cell units of the cell units. Each of the electric power adjustment units adjusts electric power generated by the solar battery and supplies the adjusted electric power to the associated cell units.

### CROSS REFERENCE TO RELATED APPLICATIONS

This application claims priority to Japanese Patent Application No. 2020-050279 filed on Mar. 19, 2020, the content of which is incorporated herein by reference.

### TECHNICAL FIELD

The present invention relates to a charging device that charges a capacitor with electric power generated by a solar battery.

### BACKGROUND ART

In recent years, various solar battery charging systems have been proposed in which a capacitor is charged with electric power generated by a solar battery. For example, JP 2014-217167 A discloses a technique in which a main battery that supplies electric power to a traveling electric motor, a solar battery, and a boost converter that boosts the electric power generated by the solar battery are provided, and the main battery is charged by boosting the electric power, which is generated by the solar battery, using the boost converter

An output voltage of a solar battery may be lower than an output voltage of a battery. In such a case, it is necessary to boost the voltage in order to charge the battery with the electric power generated by the solar battery as in JP 2014-217167 A. However, when a boost ratio during boosting is increased, the power loss during boosting increases. Meanwhile, when the output voltage of the battery is lowered, the boost ratio during charging of the battery with the electric power generated by the solar battery can be lowered, and the power loss during boosting can be reduced. However, when the output voltage of the battery is lowered, it is difficult to output required electric power from the battery. Therefore, in the related art, there is a room fir improvement in terms of efficiently charging the battery with the electric power generated by the solar battery while securing the output of the electric power from the battery.

An aspect of the present invention provides a charging device capable of efficiently charging a battery with electric power generated by a solar battery while ensuring an output of electric power from the battery.

### SUMMARY OF INVENTION

According to an aspect of the present invention, there is provided a charging device that charges a battery mounted in a vehicle, the battery having cells connected in series, the cells being configured as cell units each including at least one of the cells, the charging device including: a solar battery; and a charging circuit configured to selectively supply electric power generated by the solar battery to each of the cell units. The charging circuit includes electric power adjustment units provided between the solar battery and the cell units, and and each of the electric power adjustment units is associated with one or more cell units of the cell units. Each of the electric power adjustment units adjusts electric power generated by the solar battery and supplies the adjusted electric power to the associated cell units.

### BRIEF DESCRIPTION OF DRAWINGS

FIG. 1 is a block diagram showing a charging device according to a first embodiment of the present invention.

FIG. 2 is a block diagram showing a battery configured with cell units each of which is a single cell.

FIG. 3 is a block diagram showing a charging device according to a second embodiment of the present invention.

### DESCRIPTION OF EMBODIMENTS

Hereinafter, embodiments of a charging device of the present invention will be described with reference to the accompanying drawings.

### First Embodiment

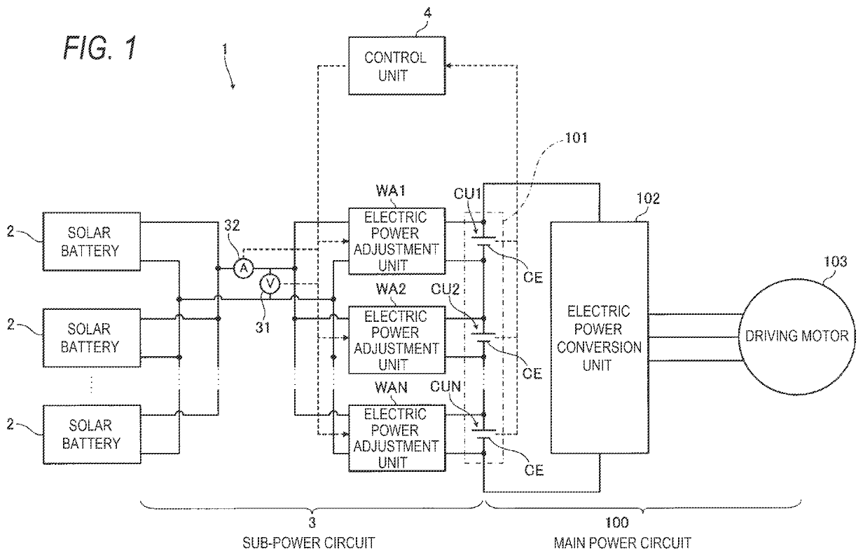

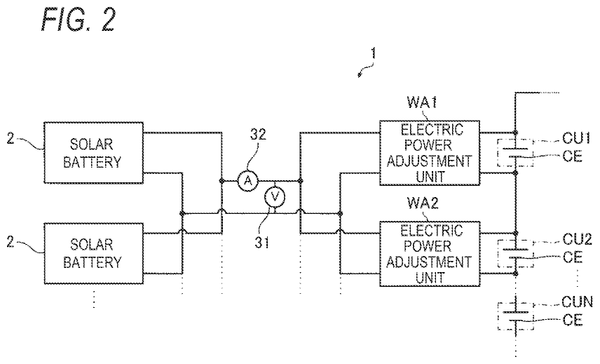

A charging device according to a first embodiment of the present invention will be described with reference to FIGS. 1 and 2.

As shown in FIGS. 1 and 2, a charging device 1 of the first embodiment includes solar batteries 2, a sub-power circuit 3 (an example of a charging circuit), and a control unit 4. The charging device 1 is a device that charges a battery 101, which will be described later, with electric power generated by the solar battery 2. The charging device 1 is mounted in, for example, a vehicle such as an electric vehicle (EV) in which the solar battery 2 is provided on a roof, or a bonnet.

The battery 101 is connected to a main power circuit 100 and is a battery for driving a vehicle driving motor 103 (an example of an electric motor) provided in the main power circuit 100. The battery 101 is configured by connecting terminals of adjacent battery cell units such that a plurality of battery cell units CUn (n=1 to N) are electrically connected in series. in the first embodiment, each battery cell unit CUn is configured with a single battery cell CE (with reference to FIG. 2). The battery 101 is configured as, for example, a cell stack in which a plurality of battery cells (battery cell units) and a plurality of insulating plates are alternately stacked. The battery 101 is, for example, a high-output battery having an output voltage of about several hundred [V], and in the high-output battery, about hundred to several hundred battery cells of various types each having an output voltage of about several [V], such as a nickel-metal hydride battery or a lithium ion battery, are connected. The battery 101 of the present embodiment is configured such that about 100 battery cells (battery cell units) each having an output voltage of about 3[V] are connected and an output voltage thereof is about 300 [V]. The output voltage (charging voltage) of each battery cell unit CUn is detected by a battery sensor (not shown) and sent to the control unit 4.

The solar battery 2 converts solar light energy into electric energy, The solar battery 2 includes a solar battery cell that receives solar light and generates electric power, and is formed in, for example, a panel shape. The solar battery cell is implemented by a photodiode or the like. In order to obtain a required voltage, a plurality of solar battery cells are connected in series to form a solar battery cell string. Further, in order to obtain a required output, a plurality of solar battery cell strings may be connected in series or in parallel so as to be configured as a solar battery cell array. A plurality of solar batteries 2 are provided and the solar batteries 2 are connected in parallel. In the present embodiment, about 20 solar batteries 2 are provided, and the output voltage of each solar battery 2 is about 24[V].

The sub-power circuit 3 is provided between the solar battery 2 and the battery 101. The sub-power circuit 3 is a charging circuit for charging the battery 101 with electric power generated by the solar battery 2. The sub-power circuit 3 is configured to selectively supply the electric power of the solar battery 2 to each battery cell unit CUn among the plurality of battery cell units CUn=1 to N) configuring the battery 101. The sub-power circuit 3 includes a voltage sensor 31, a current sensor 32, and electric power adjustment units WAn (n=1 to N).

The voltage sensor 31 detects a voltage V to be output to the electric power adjustment unit WAn from the solar battery 2. Voltage information of the detected voltage V is sent to the control unit 4. The current sensor 32 detects a current A flowing from the solar battery 2 to the electric power adjustment unit WAn. Current information of the detected current A is sent to the control unit 4.

The electric power adjustment unit WAn adjusts the electric power generated by the solar battery 2 according to a charging state of the battery cell unit CUn, and supplies the adjusted electric power to the battery cell unit CUn. The electric power adjustment unit WAn is implemented by a DC/DC converter with Maximum Power Point Tracking (MPPT).

The electric power adjustment unit WAn. (n=1 to N) is provided for each of the battery cell units CUn (n=1 to N) configuring the battery 101. The same number of electric power adjustment units WAn as the battery cell units CUn are provided, and output terminals of each electric power adjustment unit WAn are connected to both end portions of each battery cell unit CUn, respectively, That is, the electric power adjustment unit WM is connected to the battery cell unit CU1, the electric power adjustment unit WA2 is connected to the battery cell unit CU2, and the electric power adjustment unit WAn is connected to the battery cell unit CUn. The electric power adjustment unit WA1 supplies the electric power generated by the solar battery 2 to the battery cell unit CU1, the electric power adjustment unit WA2 supplies the electric power generated by the solar battery 2 to the battery cell unit CU2, and the electric power adjustment unit WAn supplies the electric power generated by the solar battery 2 to the battery cell unit CUn. A set including each electric power adjustment unit and each battery cell unit, for example, a set including the electric power adjustment unit WA1 and the battery cell unit CUT, a set including the electric power adjustment unit WA2 and the battery cell unit CU2, and a set including the electric power adjustment unit WAn and the battery cell unit CUn are configured to be independent of one another. Accordingly, the respective electric power adjustment units WAn are provided in a state of being insulated from one another.

Based on the MPPT function, the electric power adjustment unit WAn controls a voltage of the electric power adjustment unit WM such that the output electric power of the solar battery 2 is maximized. That is, the electric power adjustment unit WAn adjusts the electric power output from the solar battery 2 such that the electric power output to the battery cell unit CUn follows an optimum operating point.

The electric power adjustment unit WAn adjusts, by a voltage balance function of the DC/DC converter, the voltage output from the solar battery 2 to a predetermined voltage required on a battery cell unit CUn. In the present embodiment, the electric power adjustment unit WAn steps down the voltage output from the solar battery 2 to about 3 [V]. The DC/DC converter is configured with a switching element, a diode, or the like.

The control unit 4 controls operations of the electric power adjustment units WAn. The battery sensor of each battery cell unit CUn configuring the battery 101, each electric power adjustment unit WAn, or the like are electrically connected to the control unit 4. The control unit 4 controls an electric power adjustment unit WAn corresponding to each battery cell unit CUn based on the output voltage (charging voltage) of each battery cell unit CUn detected by the battery sensor of each battery cell unit CUn such that the voltages of the battery cell units are equal to one another. For example, the control unit 4 calculates an average charge amount of all the battery cell units CUn, and detects a battery cell unit CUn having a charge amount smaller than the calculated average charge amount. The control unit 4 selectively controls the electric power adjustment unit WAn corresponding to the battery cell unit CUn, in which the detected charge amount is small, such that the electric power of the solar battery 2 is preferentially supplied to the battery cell unit CUn.

The main power circuit 100 is connected to the battery 101, and includes an electric power conversion unit 102 and the driving motor 103. The configuration and function of the battery 101 are as described above. The electric power conversion unit 102 converts a direct current output from the battery 101 into an alternating current (for example, a three-phase current) and supplies the alternating current to the driving motor 103. The driving motor 103 is a motor that functions as a driving source for driving a vehicle.

As described above, the battery 101 is configured by connecting in series a plurality of battery cell units CUn (n=1 to N) each including a single battery cell CE. According to the configuration, a high output of the battery 101 can be secured. Further, the electric power adjustment unit WAn (n=1 to N) corresponding to each battery cell unit CUn (n=1 to N) is provided between the solar battery 2 and the battery cell unit CUn. According to the configuration, when the battery 101 is charged with the electric power generated by the solar battery 2, the battery 101 can be charged in units of the battery cell unit CUn, so that the charging voltage required when the battery 101 is charged can be reduced. Therefore, even when the output voltage of the solar battery 2 is reduced, the battery 101 can be charged without significantly increasing the output voltage of the solar battery 2. That is, the power loss when the battery 101 is charged with the electric power generated by the solar battery 2 can be reduced, and the battery 101 can be efficiently charged with the electric power generated by the solar battery 2.

In addition, each electric power adjustment unit WAn can control the output voltage of the solar battery 2 to a voltage required by each battery cell unit CUn, and can selectively supply the electric power of the solar battery 2 to each battery cell unit CUn. Therefore, the battery 101 can be efficiently charged with the electric power generated by the solar battery 2.

Further, based on the MPPT function of the electric power adjustment unit WAn, the electric power generated by the solar battery 2 can be controlled to be maximized, so that an amount of electric power generated by the solar battery 2 can be increased.

Further, the same number of electric power adjustment units WAn as the battery cell units CUn are provided, so that each electric power adjustment unit WAn and each battery cell unit CUn are set as one set and these sets are independent of one another. Accordingly, the electric power adjustment units WAn are configured to be insulated from one another. Therefore, even when a failure occurs in the function of any one of the electric power adjustment units WAn due to some factor and a reverse flow of electric power from the battery 101 to the solar battery 2 occurs, only a voltage of the battery cell unit CUn connected to the electric power adjustment unit WAn in which the failure occurs can be applied to the solar battery 2. In the present embodiment, since the output voltage of each battery cell unit CUn is a low voltage (for example, about 3[V]), a voltage of only about 3[V] can be applied to the solar battery 2.

The control unit 4 can control the electric power adjustment units WAn corresponding to the respective battery cell units CUn such that the output voltages (charging voltages) of the battery cell units CUn are substantially equal to one another. Therefore, a. decrease in output of the battery 101 caused by variation in charging voltage of each battery cell unit CUn can be prevented.

Since the battery 101 is connected to the main power circuit 100 including the driving motor 103 for driving the vehicle and the electric power conversion unit 102 for supplying electric power to the driving motor 103, the driving motor 103 of the vehicle can be driven by the electric power of the battery 101.

### Second Embodiment

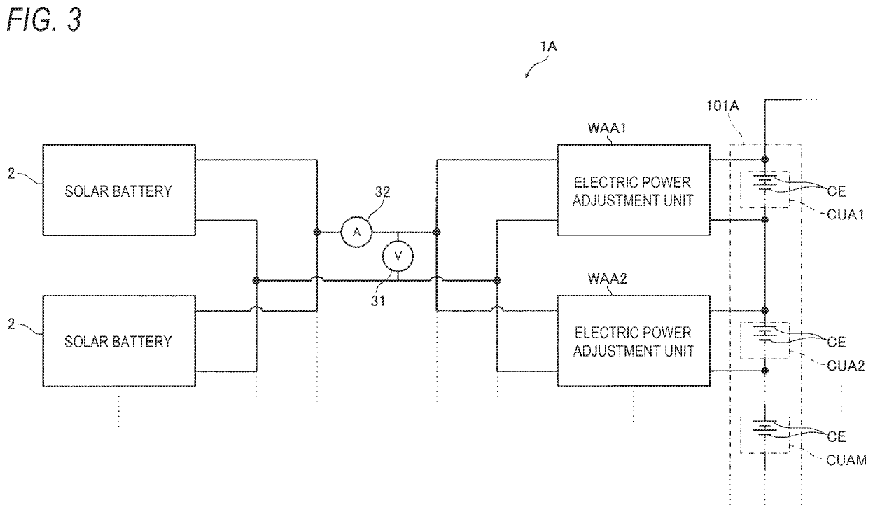

A charging device 3 A according to a second embodiment of the present invention will be described with reference to FIGS. 1 and 3. In the following description, the same components as those of the charging device 1 of the first embodiment are denoted by the same reference numerals, and the description thereof will be omitted or simplified. In the charging device 1 of the first embodiment, each of the battery cell units CUn configuring the battery 101 is formed by a single battery cell CE, whereas in the charging device 1A of the second embodiment, each of battery cell units CUAm (m=1 to M) configuring a battery 101A is formed as a battery module in which battery cells CE are stacked and integrated.

As shown in FIG. 3, an electric power adjustment unit WAAm (m=1 to M) is provided for each of the battery cell units CUAm (m=1 to M) configuring the battery 101A. The same number of electric power adjustment units WAAm as the battery cell units CUAm are provided, and output terminals of the power adjustment unit WAAm are connected to both end portions of the battery cell unit CUA1, respectively. That is, the electric power adjustment unit WAA1 is connected to the battery cell unit CUA1, the electric power adjustment unit WAA2 is connected to the battery cell unit CUA2, and the electric power adjustment unit WAAm is connected to the battery cell unit CUAm. A set including each electric power adjustment unit and each battery cell unit, for example, a set including the electric power adjustment unit WAA1 and the battery cell unit CUA1, a set including the electric power adjustment unit WAA2 and the battery cell unit CUA2, and a set including the electric power adjustment unit WAAm and the battery cell unit CUAm are configured to be independent of one another. Accordingly, the respective electric power adjustment units WAAm are provided in a state of being insulated from one another. The electric power adjustment unit WAAm adjusts the electric power generated by the solar battery 2 according to a charging state of the battery cell unit CUAm, and supplies the adjusted electric power to each corresponding battery cell unit CUAm.

According to the charging device 1A, since the battery cell units CUAm are configured as the battery module in which a plurality of battery cells CE are stacked, the battery 101A can be charged with the electric power generated by the solar battery 2 in units of battery module.

The above-described embodiments can be appropriately modified, improved, or the like. For example, in the above-described embodiments, one electric power adjustment unit WAn (WAAm) is provided for each of the battery cell units CUn (CUAm) configuring the battery 101 (101A), but one electric power adjustment unit may be provided for n (m) electric power adjustment units (2≤n<N (2≤m<M). Here, N (M) is the number of all battery cell units configuring the battery 101 (101A).).

At least the following matters are described in the present specification. Although corresponding constituent elements or the like in the above embodiment are shown in parentheses, the present invention is not limited thereto.

(1) A charging device (charging device 1) that charges a battery (battery 101) mounted in a vehicle, the battery having cells (battery cells CE) connected in series, the cells being configured as cell units (battery cell units CUn (n=1 to N)) each including at least one of the cells, the charging device including:

a solar battery (solar battery 2); and

a charging circuit (sub-power circuit 3) configured to selectively supply electric power generated by the solar battery to each of the cell units,

wherein the charging circuit includes electric power adjustment units (electric power adjustment unit WAn (n=1 to N)) provided between the solar battery and the cell units, and each of the electric power adjustment units is associated with one or more cell units of the cell units, and

wherein each of the electric power adjustment units is configured to adjust electric power generated by the solar battery and supply the adjusted electric power to the associated cell units.

According to the above (1), in the charging circuit configured to supply the electric power generated by the solar battery to each of the cell units, the electric power adjustment units are provided between the solar battery and the cell units, and each of the electric power adjustment units is associated with one or more cell units and configured to adjust the electric power generated by the solar battery and supply the adjusted electric power to the associated cell units. Accordingly, a charging voltage required to charge the battery with the electric power generated by the solar battery can be reduced while ensuring an output of the battery in which the plurality of cells are connected in series, and the battery can be efficiently charged with the electric power generated by the solar battery.

(2) The charging device according to the above (1), further including:

a control unit (control unit 4) configured to control the electric power adjustment units such that voltages of the cell units are equal to one another

According to the above (2), since the charging device includes the control unit configured to control the electric power adjustment units such that the voltages of the cell units are equal to one another, a decrease in battery output caused by variation in voltage of each cell unit can be prevented.

(3) The charging device according to (1) or (2), wherein the electric power adjustment units operate such that electric power generated by the solar battery is maximized.

According to the above (3), since the electric power adjustment units operate such that the electric power generated by the solar battery is maximized, the electric power generated by the solar battery can he increased.

(4) The charging device according to any one of the above (1) to (3), wherein each of the cell units is a battery module in which cells are stacked.

According to the above (4), since each of the cell units is a battery module in which cells are stacked, the battery can be charged in units of battery module.

(5) The charging device according to any one of the above (1) to (4), wherein the battery is connected to a main power circuit (main power circuit 100) configured to supply electric power of the battery to an electric motor (driving motor 103) configured to drive the vehicle.

According to the above (5), since the battery is connected to the main power circuit configured to supply electric power of the battery to the electric motor configured to drive the vehicle, the electric motor can be driven by the electric power of the battery

What is claimed is:

1. A charging device that charges a battery mounted in a vehicle, the battery having cells connected in series, the cells being configured as cell units each including at least one of the cells, the charging device comprising:
a solar battery; and
a charging circuit configured to selectively supply electric power generated by the solar battery to each of the cell units,
wherein the charging circuit includes electric power adjustment units provided between the solar battery and the cell units, and each of the electric power adjustment units is associated with one or more cell units of the cell units, and
wherein each of the electric power adjustment units adjusts electric power generated by the solar battery and supplies the adjusted electric power to the associated cell units.

2. The charging device according to claim 1, further comprising:
a control unit configured to control the electric power adjustment units such that voltages of the cell units are equal to one another.

3. The charging device according to claim 1, wherein
the electric power adjustment units operate such that electric power generated by the solar battery is maximized,

4. The charging device according to claim 1, wherein
each of the cell units is a battery module in which cells are stacked.

5. The charging device according to claim 1, wherein
the battery is connected to a main power circuit configured to supply electric power of the battery to an electric motor configured to drive the vehicle.
